(19) United States
(12) Patent Application Publication
(10) Pub. No.: US 2023/0232877 A1
(43) Pub. Date: Jul. 27, 2023

(54) VEGETABLE SUBSTANCE-MADE SYNTHETIC EGG

(71) Applicant: A-SHA REPUBLIC INC., Taipei City (TW)

(72) Inventor: TA-WEI LO, TAIPEI CITY (TW)

(21) Appl. No.: 17/584,401

(22) Filed: Jan. 26, 2022

(51) Int. Cl. A23L 15/00; A23L 33/185; A23L 29/269; A23L 29/256; A23L 29/00; A23L 33/14; A23L 19/00

(52) U.S. Cl. CPC A23L 15/35; A23L 33/185; A23L 29/272; A23L 29/256; A23L 29/035; A23L 33/14; A23L 29/015; A23L 19/01; A23V 2002/00

(57) ABSTRACT

A vegetable substance-made synthetic egg includes a vegetable substance-made synthetic egg powder that is in a dry form and packed in an enclosed form. To use, water of a predetermined ratio is uniformly mixed with the egg powder made of vegetable substance to make an egg liquid that is heatable and cookable to make egg cuisines of scrambled egg and fried egg, and as such, mimicking of an actual egg can be realized as being made close to the actual egg in respect of taste and quality and containing zero cholesterol and allowing for easy carrying, storing, and cooking. A composition of the egg powder made up of vegetable substances includes at least 50.00% of rice protein, 5.00% of gellan gum, 1.50% of sodium alginate, 0.50% of calcium lactate, 0.10% of lutein, 3.00% of yeast powder, 5.00% of xanthan gum and 31.90% of corn flour, and 3.00% of edible salt.

### TECHNICAL FIELD OF THE INVENTION

The present invention relates generally to a composition of a vegetable substance-made synthetic egg, and more particularly to a synthetic egg made of vegetable substances to simulate an actual egg for taste and quality being made close to the actual egg and featuring zero cholesterol and easy carrying, storage, and cooking.

### DESCRIPTION OF THE PRIOR ART

The warming of the Earth and people's demand for high level of heath, together with popularization of light and vegetarian diet bring massive discussion and enthusiastic study and development of the ideas of being plant based. Being plant based refers to using synthetic protein that is made of vegetable substance formed through photosynthesis as a substitute of egg white for applications in foods and beverages, in order to provide a replacement of animal products in respect of structure or flavor. Switching to optional plant based food and beverage not only provides benefits in respect of health, but not helps resist global warming, demonstrating meanings in both human health and environmental protection. Thus, the idea of plant based diet is catching attention and receives a substantial level of study and developments devoted thereto. In the period between 2015-2019, globally, new products of food and beverage that are claimed as being plant based have an average annular compound growth rate as high as 75%.

Further, eggs are rich in protein, fat, vitamins, and minerals that are necessary to human body, such as iron, calcium, and potassium, and have been a major source of nutrition for humans since ancient times. Although eggs have a high nutrition value, yet the high contents of cholesterol are a concern for most people. Thus, the issue of people's concern about cholesterol in having eggs as a nutrition source can be resolved by providing a synthetic egg made up of vegetable substances that are developed based on the idea of being plant based. The present invention aims to provide a synthetic egg made of vegetable substances, which successfully mimics an actual egg for being made close to the actual egg in respect of taste, while containing zero cholesterol to suit the need for healthy diet.

### SUMMARY OF THE INVENTION

The primary objective of the present invention is to provide a vegetable substance-made synthetic egg, which includes a synthetic egg powder, in a dry form, made of vegetable substances, wherein to use, the synthetic egg powder made of vegetable substance is mixed with water at a predetermined ratio and uniformly stirred to form liquid egg that is applicable for heating and cooking to make egg cuisines, such as scrambled egg and fried egg for mimicking an actual as being close to the actual egg in respect of taste and quality.

The vegetable substance-made synthetic egg discussed above includes a synthetic egg powder made up of vegetable substances and made in a dry form and packed in an enclosed form. To use, water of a predetermined ratio is uniformly mixed with the synthetic egg powder made of vegetable substances to make an egg liquid that is heatable and cookable to make egg cuisines of scrambled egg and fried egg, and as such, mimicking of an actual egg can be realized as being made close to the actual egg in respect of taste and quality and containing zero cholesterol and allowing for easy carrying, storing, and cooking.

In the vegetable substance-made synthetic egg discussed above, a composition of the vegetable substance-made synthetic egg includes at least 50.00% of rice protein, 5.00% of gellan gum, 1.50% of sodium alginate, 0.50% of calcium lactate, 0.10% of lutein, 3.00% of yeast powder, 5.00% of xanthan gum and 31.90% of corn flour, and 3.00% of edible salt.

In the vegetable substance-made synthetic egg discussed above, the synthetic egg powder made up of vegetable substances is preferably packed by an amount of 20 grains, in which the ingredients include rice protein of 10.00 grams, gellan gum of 1.00 grams, sodium alginate of 0.30 grams, calcium lactate of 0.10 grams, lutein of 0.02 grams, yeast powder of 0.60 grams, xanthan gum of 1.00 grams, corn flour of 6.38 grams, and edible salt of 0.60 grams.

To prepare the vegetable substance-made synthetic egg discussed above, a pack of 20 grams of the synthetic egg powder made up of vegetable substances is opened and poured into a container and added with water of approximately 50 grams, followed by properly stirring for uniformly mixing to show a thick viscous form that can be poured into a pan for make egg cuisines, such as scrambled egg and fried egg.

### BRIEF DESCRIPTION OF THE DRAWINGS

FIG. 1 is a formula diagram of the present invention.

FIG. 2 is a package diagram of the present invention.

FIG. 3 is a view showing the condition of preparation according to the present invention.

FIG. 4 is a schematic view showing the condition of cooking according to the present invention.

FIG. 5 is a chart showing comparison of nutrients between a vegetable substance-made synthetic egg according to the present invention and an actual egg.

### DETAILED DESCRIPTION OF THE PREFERRED EMBODIMENT

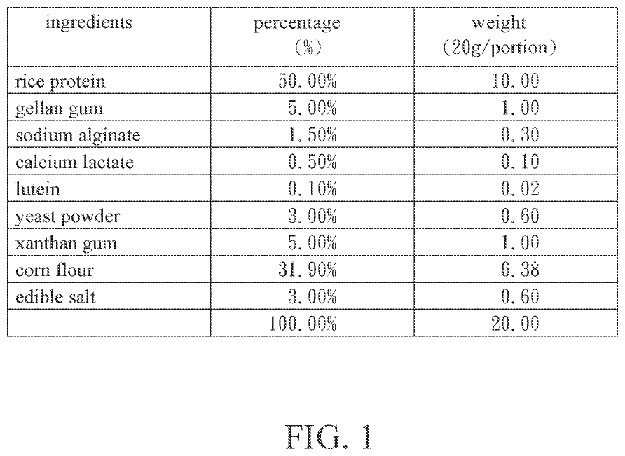

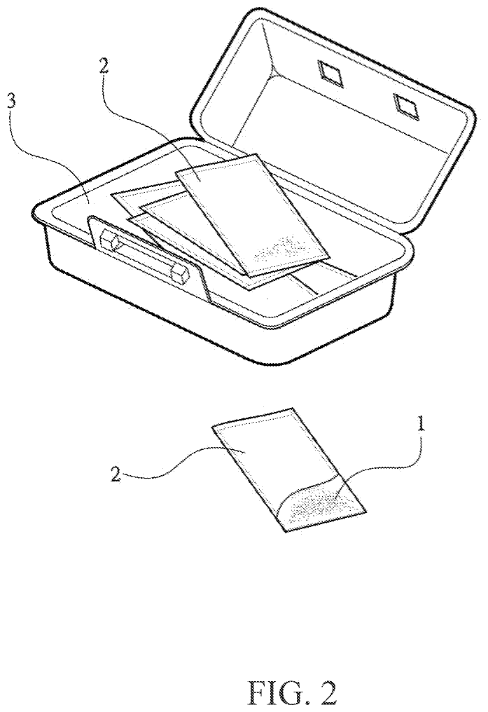

Referring to FIGS. 1 and 2, which are respectively a formula diagram and a package diagram of the present invention, as shown in the drawings, the present invention is a synthetic egg powder 1 that is made up of vegetable substances in a dry arranged in an enclosed package. In the instant embodiment, a predetermined amount of the vegetable substance-made synthetic egg powder 1 is disposed in a package bag 2 made in an enclosed form, and a predetermined quantity of the vegetable substance-made synthetic egg powder 1 is disposed in a box 3 to facilitate storage as a whole box and also for easy carrying by an individual package. The vegetable substance-made synthetic egg powder 1 has a composition that at least includes: 50.00% of rice protein, 5.00% of gellan gum, 1.50% of sodium alginate, 0.50% of calcium lactate, 0.10% of lutein, 3.00% of yeast powder, 5.00% of xanthan gum and 31.90% of corn flour, and 3.00% of edible salt.

In the composition of the vegetable substance-made synthetic egg powder 1, rice protein is a good quality vegetable protein having a complete composition of essential amino acids. The biological value of Rice protein is the highest among all sorts of grain crops and is similar to that of soybean protein, meaning excellent bioavailability; gellan gum in the composition is a water soluble high-molecular polysaccharide, oligosaccharide gum and is commonly used as a food additive to thicken and stabilize the food; sodium alginate and calcium lactate in the composition function as gum bridge to be solidified for mimicking the ingredient of egg that is curable through heating; xanthan gum in the composition is used as a thickening agent and emulsion stabilizer used in food processing; xanthan gum in the composition is a commonly used edible gum for enhancing solid taste of food; corn flour in the composition is used for provide a source of flavor and sweet and substances contained in corn flour, such as vitamin B and nicin, could help speed up the motion of human stomach and intestines after entering human body.

Preferably, the vegetable substance-made synthetic egg powder 1 is packed in an enclosed package by in an amount of 20 grains, in which, in the composition, rice protein is 10.00 grams, gellan gum 1.00 grams, sodium alginate 0.30 grams, calcium lactate 0.10 grams, lutein 0.02 grams, yeast powder 0.60 grams, xanthan gum 1.00 grams, corn flour 6.38 grams, and edible salt 0.60 grams.

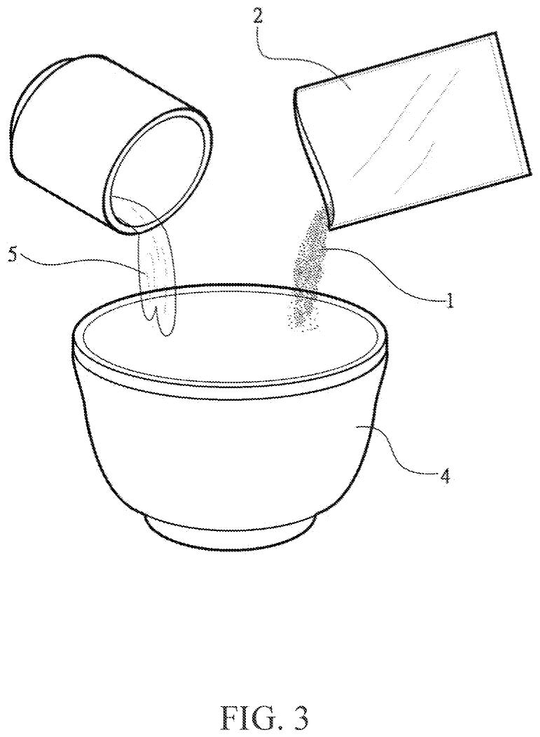

Referring to FIG. 3, which is a view showing the condition of preparation according to the present invention, as shown in the drawing, in preparation of the present invention, a pack of the vegetable substance-made synthetic egg powder 1 that contains 20 grams is opened and poured into a container 4 and is added with a predetermined amount of water 5, followed by uniformly stirring to exhibit a thick viscous condition (that is similar to a state of real egg liquid). In the instant embodiment, approximately 50 ml water 5 is added.

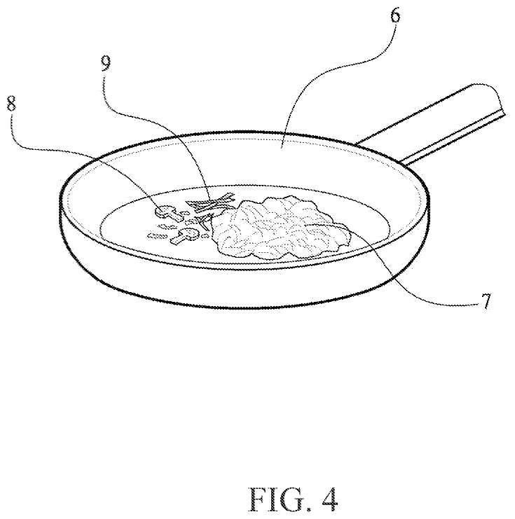

Referring to FIG. 4, wis a schematic view showing the condition of cooking according to the present invention, additional reference being had to FIG. 3, as shown in the drawings, the present invent provides the vegetable substance-made synthetic egg powder 1 and water 5 that are uniformly stirred for mixing in a thick and viscous form, as discussed above, are poured into a pan 6 that has been heated in advance for cooking. Taking scrambled egg as an example, simple stirred frying can have the thick and viscous semi-product fully cooked to make a scrambled egg cuisine 7. Of course, during the process, additional ingredients, such as mushroom 8 and onion 9, can be added, and a scrambled egg cuisine 7 can be done in a short period of time. Of course, the vegetable substance-made synthetic egg according to the present invention can be cooked, together with other ingredient, by mean of different ways of cooking to make other egg cuisines, such as omelet and fried egg.

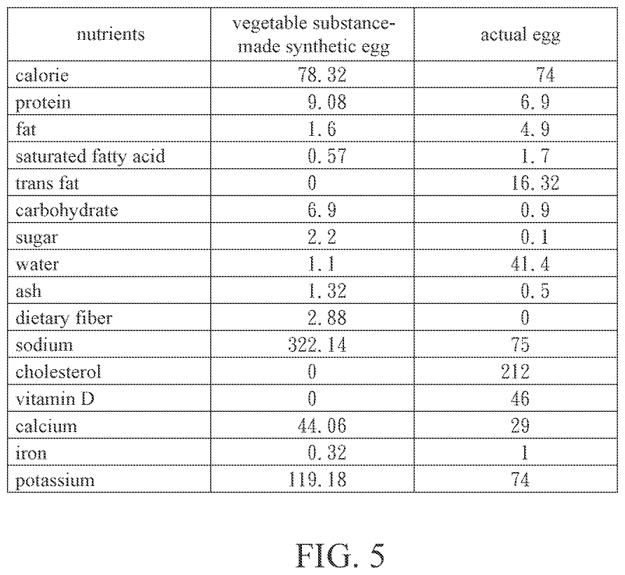

Referring to FIG. 5, which is a chart showing comparison of nutrients between a vegetable substance-made synthetic egg according to the present invention and an actual egg, as shown in the drawing, in the present invention, the vegetable substance-made synthetic egg is compared with an actual egg in respect of nutrients thereof, in which the vegetable substance-made synthetic egg has a content of protein that is 9.08 higher than that of the actual egg that is 6.90; the vegetable substance-made synthetic egg has a content of calcium that is 44.06 higher than that of the actual egg that is 29; and the vegetable substance-made synthetic egg has a content of potassium that is 119.18 higher than that of the actual egg that is 74. It is noted that, in the vegetable substance-made synthetic egg of the present invention, the contents of trans fat and cholesterol are both zero (0), and when compared with trans fat of 16.3 and cholesterol of 212 contained in the actual egg, the vegetable substance-made synthetic egg according to the present invention is obviously healthier and has a high nutritive value. Thus, the vegetable substance-made synthetic egg according of the present invention can successfully mimic the actual egg as being made close to the actual egg in respect of taste and quality, and also have advantages of low content of cholesterol and stable cost and quality and has been catching the attention of the restaurant business. There are more and more food businesses begin to use synthetic eggs made of vegetable substances, and this indicates the vegetable substance-made synthetic egg has a great market potential and a prosperous future of development.

In the embodiments discussed previously, the illustration is made only to the preferred ways of embodying the present invention and is not intended to impose unduly limitation to the scope of the present invention. Minute modifications and variations that do not depart from the spirit of the present invention are considered belonging to the scope of the present invention.

In summary, the present invention provides multiple plant based ingredients are composed, at a proper ratio, to make a vegetable substance-made synthetic egg powder, and, when used, the vegetable substance-made synthetic egg powder is mixed, at a predetermined ratio, with water through uniform stirring to make an egg liquid that can be heated and cooked to make various egg cuisines, such as scrambled egg and fried egg, and that can closely mimic or simulate an actual egg as being made close to the actual egg in respect of taste and quality.

I claim:

1. A vegetable substance-made synthetic egg, which includes a synthetic egg powder made up of vegetable substances, wherein in use, water of a predetermined ratio is uniformly mixed with the egg powder made of vegetable substance to make an egg liquid that is heatable and cookable to make egg cuisines of scrambled egg and fried egg, wherein the egg powder made up of vegetable substances is in a dry form and has a composition including at least 50.00% of rice protein, 5.00% of gellan gum, 1.50% of sodium alginate, 0.50% of calcium lactate, 0.10% of lutein, 3.00% of yeast powder, 5.00% of xanthan gum and 31.90% of corn flour, and 3.00% of edible salt.

2. The vegetable substance-made synthetic egg according to claim 1, wherein the vegetable substance-made synthetic egg and water are mixed at such a ratio that 20 grains of the vegetable substance-made synthetic egg are added with 50 ml water.

3. The vegetable substance-made synthetic egg according to claim 1, wherein the egg powder made up of vegetable substances and in a dry form is packed in a package bag in an enclosed form to facilitate carrying and storing.
